(19) United States
(12) Patent Application Publication
(10) Pub. No.: US 2026/0072787 A1
(43) Pub. Date: Mar. 12, 2026

(54) NONVOLATILE MEMORY DEVICE, MEMORY SYSTEM AND METHOD OF OPERATING THE SAME

(71) Applicant: Samsung Electronics Co., Ltd., Suwon-si (KR)

(72) Inventors: Sangsoo Park, Suwon-si (KR); Jinyoung Kim, Suwon-si (KR); Sehwan Park, Suwon-si (KR); Eunhyang Park, Suwon-si (KR)

(21) Appl. No.: 19/286,547

(22) Filed: Jul. 31, 2025

(30) Foreign Application Priority Data
Sep. 10, 2024 (KR) 10-2024-0122787

(51) Int. Cl. G06F 11/10

(52) U.S. Cl. CPC G06F 11/1068; G06F 11/1044; G06F 11/1048

(57) ABSTRACT

A memory system includes a nonvolatile memory device including a memory cell array and an on-chip syndrome checker, and a memory controller including an error check code (ECC) decoder and configured to control operation of the nonvolatile memory device. The nonvolatile memory device is configured to sequentially read out and store hard-decision data and soft-decision data from the memory cell array based on one read command transferred from the memory controller. The on-chip syndrome checker of the nonvolatile memory device is configured to generate a syndrome result value by calculating a syndrome of the hard-decision data. The ECC decoder of the memory controller is configured to, depending on the syndrome result value, either perform hard-decision ECC decoding based on the hard-decision data or perform soft-decision ECC decoding based on the hard-decision data and the soft-decision data by omitting the hard-decision ECC decoding.

### CROSS-REFERENCE TO RELATED APPLICATION

This U.S. non-provisional application claims priority under 35 USC § 119 to Korean Patent Application No. 10-2024-0122787, filed on Sep. 10, 2024, in the Korean Intellectual Property Office (KIPO), the disclosure of which is incorporated by reference herein in its entirety.

### BACKGROUND

Example implementations relate generally to semiconductor integrated circuits, and more particularly to a nonvolatile memory device, a memory system and a method of operating a memory system.

Memory devices such as a flash memory device, a resistive memory device, etc., may store data in accordance with a plurality of threshold voltage distributions or a plurality of resistance distributions, where each respective threshold voltage distribution or resistance distribution is assigned to a corresponding logic state for stored data. The data stored by a memory cell may be read by determining whether the memory cell is turned ON/OFF when a predetermined read voltage is applied. During (and/or following) the programming of a memory cell, the intended threshold voltage distribution or resistance distribution of the memory cell may be undesirably distorted due to a number of events or conditions including, e.g., charge leakage, program disturbances, read disturbances, word and/or bitline coupling, temperature change, voltage change, degeneration of the memory cell, etc. For example, the intended threshold voltage distribution or resistance distribution may be shifted and/or broadened and cause a read error such that wrong data different from the stored data are read out.

### SUMMARY

Some example implementations may provide a nonvolatile memory device, a memory system and a method of operating a memory system, capable of efficiently correcting errors in read data.

According to example implementations, a memory system includes a nonvolatile memory device including a memory cell array and an on-chip syndrome checker circuit, and a memory controller including an error check code (ECC) decoder and configured to control operation of the nonvolatile memory device. The nonvolatile memory device is configured to sequentially read out and store hard-decision data and soft-decision data from the memory cell array based on a read command transferred from the memory controller. The on-chip syndrome checker circuit of the nonvolatile memory device is configured to generate a syndrome result value by calculating a syndrome of the hard-decision data. The ECC decoder of the memory controller is configured to, based on the syndrome result value, either perform hard-decision ECC decoding based on the hard-decision data or perform soft-decision ECC decoding based on the hard-decision data and the soft-decision data.

According to example implementations, a nonvolatile memory device includes a memory cell array and an on-chip syndrome checker circuit configured to generate a syndrome result value by calculating a syndrome of hard-decision data and to read from the memory cell array. The nonvolatile memory device is configured to sequentially read out and store the hard-decision data and soft-decision data from the memory cell array based on a read command transferred from a memory controller, to transfer the hard-decision data and the soft-decision data to the memory controller based on the syndrome result value being greater than a threshold value, and to transfer the hard-decision data excluding the soft-decision data to the memory controller based on the syndrome result value being less than or equal to a threshold value.

According to example implementations, a method of operating a memory system including a nonvolatile memory device and a memory controller, includes, by the nonvolatile memory device, sequentially reading out and storing hard-decision data and soft-decision data from a memory cell array based on a read command transferred from the memory controller, by an on-chip syndrome checker circuit of the nonvolatile memory device, generating a syndrome result value by calculating a syndrome of the hard-decision data, and by an error check code (ECC) decoder of the memory controller, based on the syndrome result value, performing either hard-decision ECC decoding based on the hard-decision data or soft-decision ECC decoding based on the hard-decision data and the soft-decision data.

The nonvolatile memory device, the memory system, and the method of operating the memory system according to example implementations may, using the on-chip syndrome checker circuit included in the nonvolatile memory device, reduce latency of ECC decoding and improve performance of the memory system by omitting the hard-decision ECC decoding and immediately performing the soft-decision ECC decoding when the hard-decision ECC decoding has a high probability of failure. By integrating the on-chip syndrome checker circuits in the nonvolatile memory devices, which has the smaller size than the ECC decoder, the performance may be efficiently improved without degrading the design margin of the nonvolatile memory device.

### BRIEF DESCRIPTION OF THE DRAWINGS

Example implementations of the present disclosure will be more clearly understood from the following detailed description taken in conjunction with the accompanying drawings.

FIG. 1 is a block diagram illustrating a memory system according to example implementations.

FIG. 2 is a flowchart illustrating a method of operating a memory system according to example implementations.

FIG. 3 is a block diagram illustrating example implementations of a memory controller included in a memory system according to example implementations.

FIG. 4 is a block diagram illustrating a nonvolatile memory device according to example implementations.

FIG. 5 is a block diagram illustrating a memory system according to example implementations.

FIG. 6 is a block diagram illustrating a memory cell array included in the nonvolatile memory device of FIG. 4.

FIG. 7 is a circuit diagram illustrating an equivalent circuit of a memory block included in the memory cell array of FIG. 6.

FIG. 8 is a diagram illustrating example states of multi-level cells included in a nonvolatile memory device according to example implementations.

FIG. 9 is a diagram illustrating degenerated states from the states of FIG. 8.

FIG. 10 is a diagram illustrating an example of a 2-bit soft-decision read operation of a nonvolatile memory device included in a memory system according to example implementations.

FIG. 11 is a diagram illustrating an example of a log likelihood ratio (LLR) corresponding to the 2-bit soft-decision read operation of FIG. 10.

FIG. 12 is a diagram illustrating a relationship between a number of error bits and a syndrome result value with respect to read data of a nonvolatile memory device.

FIG. 13 is a diagram for describing operation of an on-chip syndrome checker included in a nonvolatile memory device according to example implementations.

FIG. 14 is a diagram illustrating example implementations of generating a flag based on a syndrome result value in a memory system according to example implementations.

FIGS. 15, 16 and 17 are flowcharts illustrating operation of a memory system according to example implementations.

FIGS. 19 and 20 are diagrams illustrating example implementations of an on-chip syndrome checker included in a nonvolatile memory device according to example implementations.

FIG. 21 is a diagram illustrating example implementations of transferring read data in a memory system according to example implementations.

FIG. 22 is a diagram illustrating a low-density parity check code for error correction in a memory system according to example implementations.

FIG. 23 is a block diagram illustrating an ECC decoder according to example implementations.

FIG. 24 is a diagram illustrating an example of a 3-bit soft-decision read operation of a nonvolatile memory device included in a memory system according to example implementations.

FIG. 25 is a diagram illustrating an example of an LLR corresponding to the 3-bit soft-decision read operation of FIG. 24.

FIG. 26 is a flowchart illustrating a method of operating a memory system according to example implementations.

FIG. 27 is a diagram illustrating example implementations of generating a flag based on a syndromic result value in a memory system according to example implementations.

FIG. 28 is a diagram for describing a fabrication process of a stacked semiconductor device according to example implementations.

FIG. 29 is a block diagram illustrating a data center including a storage device according to example implementations.

### DETAILED DESCRIPTION

Various example implementations will be described more fully hereinafter with reference to the accompanying drawings, in which some example implementations are shown. In the drawings, like numerals refer to like elements throughout. The repeated descriptions may be omitted.

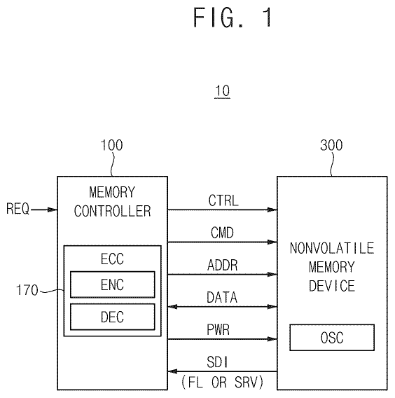

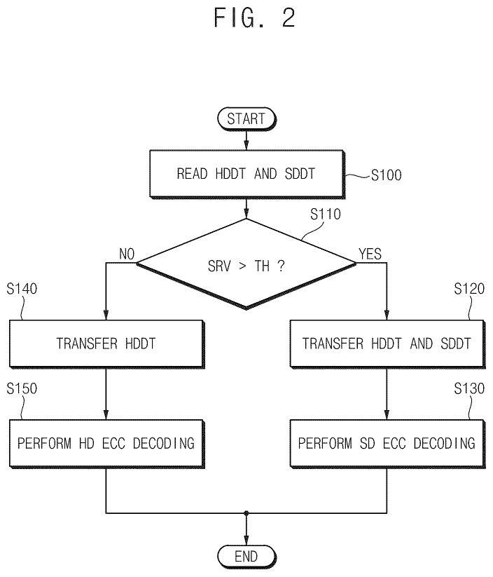

FIG. 1 is a block diagram illustrating a memory system according to example implementations, and FIG. 2 is a flowchart illustrating a method of operating a memory system according to example implementations.

Referring to FIG. 1, a memory system 10 may include a memory controller (or storage controller) 100 and at least one nonvolatile memory device 300. The memory system 10 illustrated in FIG. 1 may include a data storage medium based on flash memory, such as a memory card, USB memory, SSD, or the like.

The nonvolatile memory device 300 may perform erase, write, or read operations, or the like, under control of the memory controller 100. The nonvolatile memory device 300 receives commands CMD such as read commands and write commands, and addresses ADDR such as read addresses and write addresses, from the memory controller 100 via input and output lines, and transfers and receives data DATA for the read operations or the write operations (or program operations) with the memory controller 100. In addition, the nonvolatile memory device 300 may receive a control signal CTRL via a control line, and the nonvolatile memory device 300 may receive power PWR from the memory controller 100.

The memory controller 100 may include an ECC engine 170, and the nonvolatile memory device 300 may include an on-chip syndrome checker OSC.

The ECC engine 170 may include an ECC encoder ENC and an ECC decoder DEC. The ECC encoder ENC may perform ECC encoding on write data to be stored in the nonvolatile memory device 300 to generate encoded data, i.e., codewords. The ECC decoder DEC may perform ECC decoding on the read data in the form of codewords read from the nonvolatile memory device 300 to correct errors in the read data.

Referring to FIGS. 1 and 2, the nonvolatile memory device 300 may sequentially read out and store the hard-decision data and the soft-decision data from a memory cell array of the nonvolatile memory device 300 based on one read command transferred from the memory controller 100 (S100).

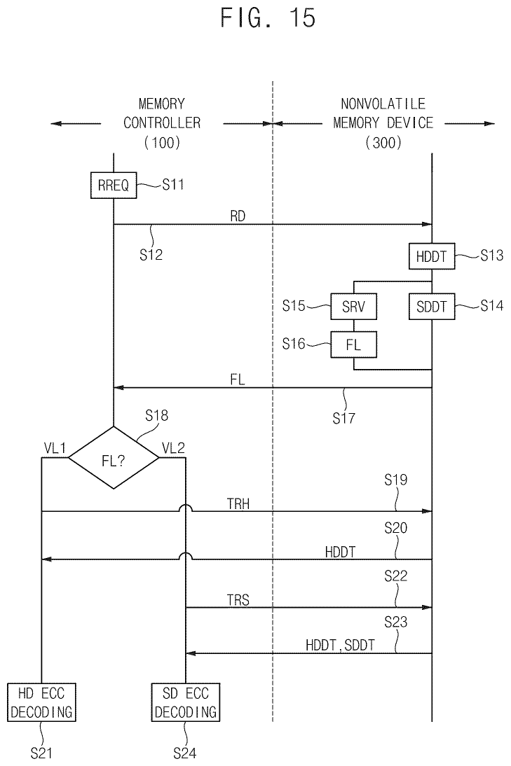

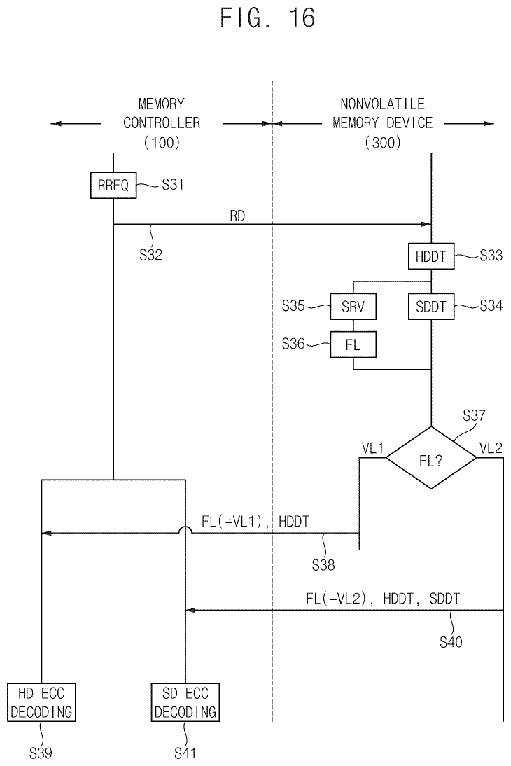

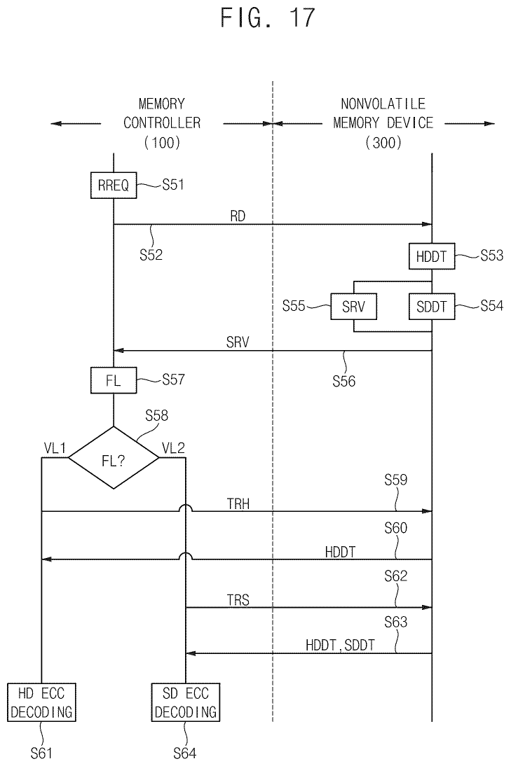

The on-chip syndrome checker OSC included in the nonvolatile memory device 300 may calculate the syndrome of the soft-decision data to generate a syndrome result value SRV. In an example embodiment, as will be described below with reference to FIG. 17, the nonvolatile memory device 300 may provide the syndrome result value SRV to the memory controller 100 as syndrome information SDI. In another example embodiment, as will be described below with reference to FIGS. 15 and 16, the nonvolatile memory device 300 may generate a flag FL based on the syndrome result value SRV and provide the flag FL to the memory controller 100 as syndrome information SDI.

Depending on the syndrome result value SRV, hard-decision ECC decoding may be performed based on the hard-decision data or soft-decision ECC decoding may be performed based on the hard-decision data and the soft-decision data by omitting the hard-decision ECC decoding.

According to example implementations, the nonvolatile memory device 300 or memory controller 100 may compare the syndrome result value SRV with a threshold value TH (S110).

When the syndrome result value SRV is greater than the threshold value TH (S110: YES), the nonvolatile memory device 300 may transfer the hard-decision data HDDT and the soft-decision data SDDT to the memory controller 100 (S120), and the ECC decoder DEC may perform the soft-decision (SD) ECC decoding based on the hard-decision data HDDT and the soft-decision data SDDT (S130).

On the other hand, when the syndrome result value SRV is not greater than (i.e., less than or equal to) the threshold value TH (S110: NO), the nonvolatile memory device 300 may transfer the hard-decision data HDDT excluding the soft-decision data SDDT to the memory controller 100 (S140). The ECC decoder DEC may perform hard-decision (HD) ECC decoding based on the hard-decision data HDDT (S150).

As such, the nonvolatile memory device 300, the memory system 10, and the method of operation of the memory system 10 according to example implementations may, using the on-chip syndrome checker OSC included in the nonvolatile memory device 300, reduce latency of the ECC decoding and improve performance of the memory system 10 by omitting the hard-decision ECC decoding and immediately performing the soft-decision ECC decoding when the hard-decision ECC decoding has a high probability of failure. By integrating the on-chip syndrome checkers OSC in the nonvolatile memory devices 300, which has the smaller size than the ECC decoder DEC, the performance may be efficiently improved without degrading the design margin of the nonvolatile memory device 300.

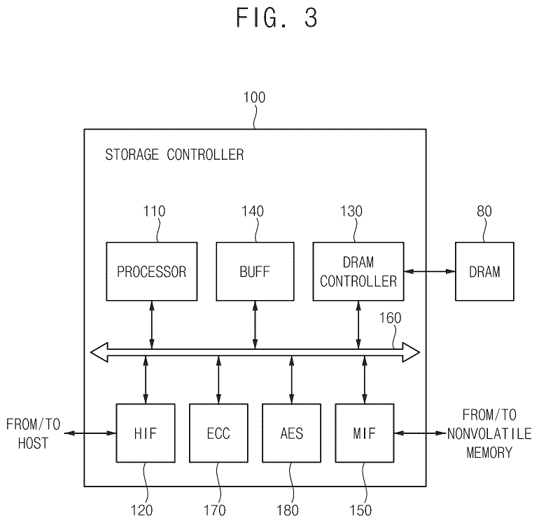

FIG. 3 is a block diagram illustrating an example implementation of a memory controller included in a memory system according to example implementations.

Referring to FIG. 3, a memory controller or storage controller 100 may include a processor 110, a buffer memory (BUFF) 140, a DRAM controller 130, a host interface (HIF) 120, an error correction code (ECC) engine 170, a memory interface (MIF) 150, an advanced encryption standard (AES) engine 180, and an internal bus 160 electrically connecting the components.

The processor 110 may control the operation of the storage controller 100 in response to commands received via the host interface 120 from an external host device. For example, the processor 110 may control the operation of a memory system (e.g., 10 in FIG. 1) and may employ firmware to drive the memory system 10 to control respective components.

The buffer memory 140 may store instructions and data that are executed and processed by the processor 110. For example, the buffer memory 140 may be implemented as volatile memory, such as SRAM, DRAM, or the like.

The ECC engine 170 for error correction may perform ECC encoding and ECC decoding using error correction code such as Bose-Chaudhuri-Hocquenghem (BCH) code, Low Density Parity Check (LDPC) code, Turbo Code, Reed-Solomon Code, Convolution Code, Recursive Systematic Code (RSC), Coded Modulation, such as Trellis-Coded Modulation (TCM), Block Coded Modulation (BCM), Hamming code, and so on.

The host interface 120 may provide a physical connection between the host device and the storage controller 100, i.e., the host interface 120 may provide interfacing with the storage controller 100 in a bus format corresponding to the bus format of the host device. In an example embodiment, the bus format of the host device may be SCSI or SAS. In other example implementations, the bus format of the host device may be USB, peripheral component interconnect express (PCIe), ATA, PATA, SATA, NVMe, or the like.

The memory interface 150 may exchange data with a nonvolatile memory device (e.g., 300 in FIG. 1). The memory interface 150 may transfer write data to the nonvolatile memory device 300, and may receive read data from the nonvolatile memory device 300. For example, the memory interface 150 may utilize a standard protocol such as Toggle or ONFI.

The AES engine 180 may perform at least one of encryption operations and decryption operations on data input to the storage controller 100, using a symmetric-key algorithm. The AES engine 180 may include an encryption module and a decryption module. Depending on example embodiment, the encryption module and the decryption module may be implemented as separate modules or may be implemented as a single module.

The processor 110 may access the external DRAM 80 via the DRAM controller 130. The processor 110 may control the DRAM controller 130, the memory interface 150, and the host interface 120 to transfer user data stored in the external DRAM 80 to the nonvolatile memory device 300 or to an external host device.

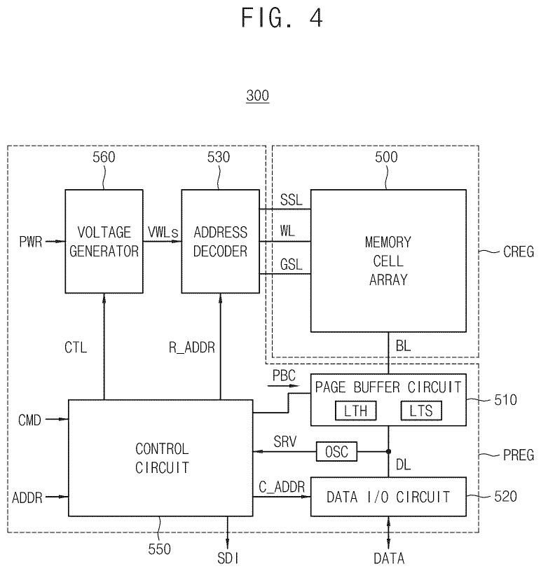

FIG. 4 is a block diagram illustrating a nonvolatile memory device according to example implementations.

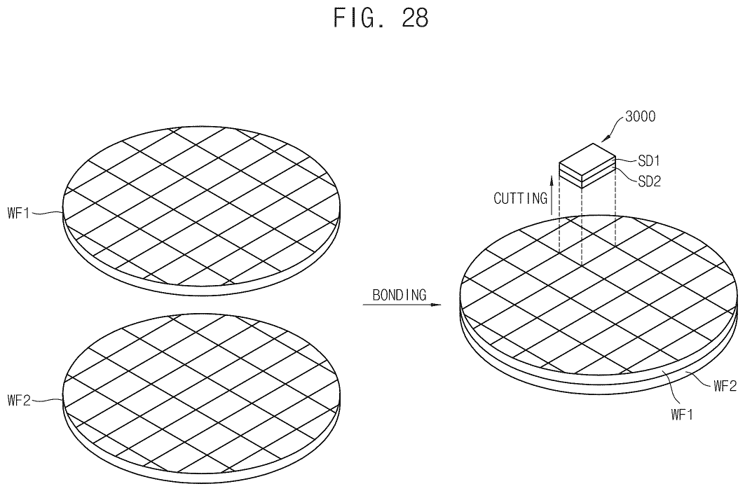

Referring to FIG. 4, a nonvolatile memory device 300 may include a memory cell array 500, a page buffer circuit 510, a data input/output (I/O) circuit 520, an address decoder 530, a control circuit 550, a voltage generator 560 and an on-chip syndrome checker OSC. The memory cell array 500 may be disposed in the cell region CREG. The page buffer circuit 510, the data I/O circuit 520, the address decoder 530, the control circuit 550, the voltage generator 560 and the on-chip syndrome checker OSC may be disposed in the peripheral region PREG. As will be described below with reference to FIG. 28, the cell region CREG and the peripheral region PREC may be formed and disposed in different wafers.

The memory cell array 500 may be coupled to the address decoder 530 through string selection lines SSL, wordlines WL, and ground selection lines GSL. In addition, the memory cell array 500 may be coupled to the page buffer circuit 510 through bitlines BL. The memory cell array 500 may include memory cells coupled to the wordlines WL and the bitlines BL. In some example implementations, the memory cell array 500 may be a three-dimensional memory cell array, which is formed on a substrate in a three-dimensional structure (for example, a vertical structure). In this case, the memory cell array 500 may include cell strings (e.g., NAND strings) that are vertically oriented such that at least one memory cell is overlapped vertically with another memory cell.

The control circuit 550 may receive a command (signal) CMD and an address (signal) ADDR from a memory controller. Accordingly, the control circuit 550 may control erase, program and read operations of the nonvolatile memory device 300 in response to (or based on) at least one of the command signal CMD and the address signal ADDR. An erase operation may include performing a sequence of erase loops. A program operation may include performing a sequence of program loops. Each program loop may include a program operation and a program verification operation. Each erase loop may include an erase operation and an erase verification operation. The read operation may include a normal read operation and a data recover read operation.

For example, the control circuit 550 may generate the control signals CTL used to control the operation of the voltage generator 560. The control circuit 550 may also generate the page buffer control signal PBC for controlling the page buffer circuit 510 based on the command signal CMD, and generate the row address R_ADDR and the column address C_ADDR based on the address signal ADDR. The control circuit 550 may provide the row address R_ADDR to the address decoder 530 and provide the column address C_ADDR to the data I/O circuit 520.

The address decoder 530 may be coupled to the memory cell array 500 through the string selection lines SSL, the wordlines WL, and the ground selection lines GSL. During the program operation or the read operation, the address decoder 530 may determine or select one of the wordlines WL as a selected wordline and determine the remaining wordlines WL except for the selected wordline as unselected wordlines based on the row address R_ADDR.

During the program operation or the read operation, the address decoder 530 may determine one of the string selection lines SSL as a selected string selection line and determine the remaining string selection lines SSL except for the selected string selection line as unselected string selection lines based on the row address R_ADDR.

The voltage generator 560 may generate wordline voltages VWL, which are required for the operation of the memory cell array 500 of the nonvolatile memory device 300, based on the control signals CTL. The voltage generator 560 may receive power PWR from a memory controller such as the memory controller 100 in FIG. 1. The wordline voltages VWL may be applied to the wordlines WL through the address decoder 530.

For example, during the erase operation, the voltage generator 560 may apply an erase voltage to a well and/or a common source line of a memory block and apply an erase permission voltage (e.g., a ground voltage) to all or a portion of the wordlines of the memory block based on an erase address. During the erase verification operation, the voltage generator 560 may apply an erase verification voltage simultaneously to all of the wordlines of the memory block or sequentially (e.g., one by one) to the wordlines.

For example, during the program operation, the voltage generator 560 may apply a program voltage to the selected wordline and may apply a program pass voltage to the unselected wordlines. In addition, during the program verification operation, the voltage generator 560 may apply a program verification voltage to the first wordline and may apply a verification pass voltage to the unselected wordlines.

During the normal read operation, the voltage generator 560 may apply a read voltage to the selected wordline and may apply a read pass voltage to the unselected wordlines. During the data recover read operation, the voltage generator 560 may apply the read voltage to a wordline adjacent to the selected wordline and may apply a recover read voltage to the selected wordline.

The page buffer circuit 510 may be coupled to the memory cell array 500 through the bitlines BL. The page buffer circuit 510 may include multiple buffers. In some example implementations, each buffer may be connected to a single bitline. In other example implementations, each buffer may be connected to two or more bitlines. The page buffer circuit 510 may temporarily store data to be programmed in a selected page or data read out from the selected page of the memory cell array 500.

As described above, the nonvolatile memory device 300 may sequentially read out and store the hard-decision data and the soft-decision data based on a single read command. For such sequential read operation, the page buffer circuit 510 may include a latch LTH configured to store the hard-decision data and a latch LTS configured to store the soft-decision data.

The data I/O circuit 520 may be coupled to the page buffer circuit 510 through data lines DL. During the program operation, the data I/O circuit 520 may receive program data DATA received from the memory controller and provide the program data DATA to the page buffer circuit 510 based on the column address C_ADDR received from the control circuit 550. During the read operation, the data I/O circuit 520 may provide read data DATA, having been read from the memory cell array 500 and stored in the page buffer circuit 510, to the memory controller based on the column address C_ADDR received from the control circuit 550.

In addition, the page buffer circuit 510 and the data I/O circuit 520 may read data from a first area of the memory cell array 500 and write the read data to a second area of the memory cell array 500 (e.g., without transferring the data to a source external to the nonvolatile memory device 300, such as to the memory controller). For example, the page buffer circuit 510 and the data I/O circuit 520 may perform a copy-back operation.

The on-chip syndrome checker OSC may generate the syndrome result value SRV by calculating the syndrome of the hard-decision data stored in the latch LTH. According to example implementations, the control circuit 550 may provide the syndrome result value SRV or a flag FL based on the syndrome result value SRV to the memory controller 100 as syndrome information SDI.

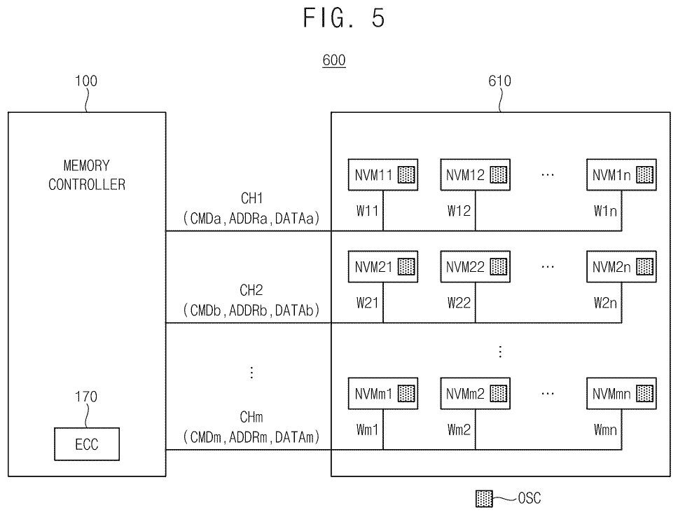

FIG. 5 is a block diagram illustrating a memory system according to example implementations.

Referring to FIG. 5, a memory system or a storage device 600 may include a nonvolatile memory device 610 and a memory controller 100. The storage device 600 may support a plurality of channels CH1, CH2, . . . , CHm, and nonvolatile the memory device 610 may be connected to the memory controller 100 through the plurality of channels CH1 to CHm. For example, the storage device 600 may be implemented as a universal flash storage (UFS), a solid state drive (SSD), or the like. The storage device 600 may correspond to the memory system 10 of FIG. 1.

The nonvolatile memory device 610 may include a plurality of nonvolatile memories NVM11, NVM12, . . . , NVM1n, NVM21, NVM22, . . . , NVM2n, NVMm1, NVMm2, . . . , NVMmn. Here, n and m may each be integers. Each of the nonvolatile memories NVM11 to NVMmn may be connected to one of the plurality of channels CH1 to CHm through a way corresponding thereto. For example, the nonvolatile memories NVM11 to NVM1n may be connected to the first channel CH1 through ways W11, W12, . . . , W1n, the nonvolatile memories NVM21 to NVM2n may be connected to the second channel CH2 through ways W21, W22, . . . , W2n, and the nonvolatile memories NVMm1 to NVMmn may be connected to the m-th channel CHm through ways Wm1, Wm2, . . . , Wmn. In some example implementations, each of the nonvolatile memories NVM11 to NVMmn may be implemented as a memory unit that may operate according to an individual command from the memory controller 100. For example, each of the nonvolatile memories NVM11 to NVMmn may be implemented as a chip or a die, but example implementations are not limited thereto.

The memory controller 100 may transmit and receive signals to and from the nonvolatile memory device 610 through the plurality of channels CH1 to CHm. For example, the memory controller 100 may transmit commands CMDa, CMDb, . . . , CMDm, addresses ADDRa, ADDRb, . . . , ADDRm and data DATAa, DATAb, . . . , DATAm to the nonvolatile memory device 610 through the channels CH1 to CHm, or may receive the data DATAa to DATAm from the nonvolatile memory device 610 through the channels CH1 to CHm.

The memory controller 100 may select one of the nonvolatile memories NVM11 to NVMmn, which is connected to each of the channels CH1 to CHm, using a corresponding one of the channels CH1 to CHm, and may transmit and receive signals to and from the selected nonvolatile memory. For example, the memory controller 100 may select the nonvolatile memory NVM11 from among the nonvolatile memories NVM11 to NVM1n connected to the first channel CH1. The memory controller 100 may transmit the command CMDa, the address ADDRa and the data DATAa to the selected nonvolatile memory NVM11 through the first channel CH1 or may receive the data DATAa from the selected nonvolatile memory NVM11 through the first channel CH1.

The memory controller 100 may transmit and receive signals to and from the nonvolatile memory device 610 in parallel through different channels. For example, the memory controller 100 may transmit the command CMDb to the nonvolatile memory device 610 through the second channel CH2 while transmitting the command CMDa to the nonvolatile memory device 610 through the first channel CH1. For example, the memory controller 100 may receive the data DATAb from the nonvolatile memory device 610 through the second channel CH2 while receiving the data DATAa from the nonvolatile memory device 610 through the first channel CH1.

The memory controller 100 may control overall operations of the nonvolatile memory device 610. The memory controller 100 may transmit a signal to the channels CH1 to CHm and may control each of the nonvolatile memories NVM11 to NVMmn connected to the channels CH1 to CHm. For example, the memory controller 100 may transmit the command CMDa and the address ADDRa to the first channel CH1 and may control one selected from among the nonvolatile memories NVM11 to NVM1n.

Each of the nonvolatile memories NVM11 to NVMmn may operate under the control of the memory controller 100. For example, the nonvolatile memory NVM11 may program the data DATAa based on the command CMDa, the address ADDRa and the data DATAa provided from the memory controller 100 through the first channel CH1. For example, the nonvolatile memory NVM21 may read the data DATAb based on the command CMDb and the address ADDRb provided from the memory controller 100 through the second channel CH2 and may transmit the read data DATAb to the memory controller 100 through the second channel CH2.

Although FIG. 5 illustrates an example where the nonvolatile memory device 610 communicates with the memory controller 100 through m channels and includes n nonvolatile memories corresponding to each of the channels, example implementations are not limited thereto and the number of channels and the number of nonvolatile memories connected to one channel may be variously changed.

According to example implementations, the storage device 600 may include an ECC engine 170, and a plurality of nonvolatile memories NVM11, NVM12, . . . , NVM1n, NVM21, NVM22, . . . , NVM2n, NVMm1, NVMm2, . . . , NVMmn may include an on-chip syndrome checker OSC. The on-chip syndrome checker OSC may provide a syndrome result value SRV with respect to the hard decision data HDDT read from the corresponding nonvolatile memory.

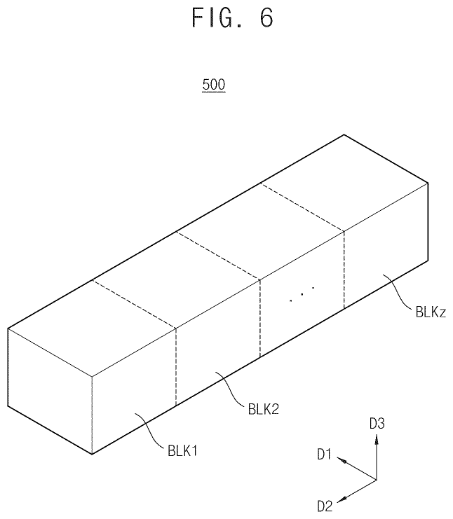

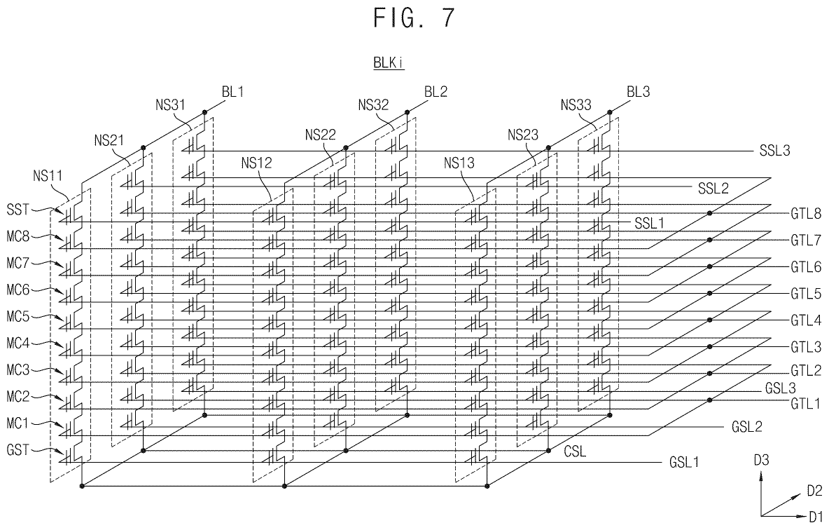

FIG. 6 is a block diagram illustrating a memory cell array included in the nonvolatile memory device of FIG. 4, and FIG. 7 is a circuit diagram illustrating an equivalent circuit of a memory block included in the memory cell array of FIG. 6.

Referring to FIG. 6, the memory cell array 500 may include memory blocks BLK1 to BLKz. In some example implementations, the memory blocks BLK1 to BLKz may be selected by the address decoder 530 in FIG. 4. For example, the address decoder 530 may select a particular memory block BLK among the memory blocks BLK1 to BLKz corresponding to a block address.

The memory block BLKi of FIG. 7 may be formed on a substrate in a three-dimensional structure (for example, a vertical structure). For example, NAND strings or cell strings included in the memory block BLKi may be disposed in the vertical direction D3 perpendicular to the upper surface of the substrate.

Referring to FIG. 7, the memory block BLKi may include cell strings or NAND strings NS11 to NS33 coupled between bitlines BL1, BL2 and BL3 and a common source line CSL. Each NAND string may include a plurality of memory cells stacked in the vertical direction D3, and the plurality of wordlines may be stacked in the vertical direction D3.

Each of the NAND strings NS11 to NS33 may include a string selection transistor SST, memory cells MC1 to MC8, and a ground selection transistor GST. In FIG. 7, each of the NAND strings NS11 to NS33 is illustrated to include eight memory cells MC1 to MC8. However, example implementations are not limited thereto. In some example implementations, each of the NAND strings NS11 to NS33 may include any number of memory cells.

Each string selection transistor SST may be connected to a corresponding string selection line (for example, one of SSL1 to SSL3). The memory cells MC1 to MC8 may be connected to corresponding gate lines GTL1 to GTL8, respectively. The gate lines GTL1 to GTL8 may be wordlines. Some of the gate lines GTL1 to GTL8 may be dummy wordlines. Each ground selection transistor GST may be connected to a corresponding ground selection line (for example, one of GSL1 to GSL3). Each string selection transistor SST may be connected to a corresponding bitline (e.g., one of BL1, BL2 and BL3). Each ground selection transistor GST may be connected to the common source line CSL.

The Wordline (each of the gate lines GTL1 to GTL8) having the same height may be commonly connected. The ground selection lines GSL1 to GSL3 and the string selection lines SSL1 to SSL3 may be separated. In FIG. 7, the memory block BLKi is illustrated to be coupled to eight gate lines GTL1 to GTL8 and three bitlines BL1 to BL3. However, example implementations are not limited thereto. Each memory block in the memory cell array 500 may be coupled to any number of wordlines and any number of bitlines.

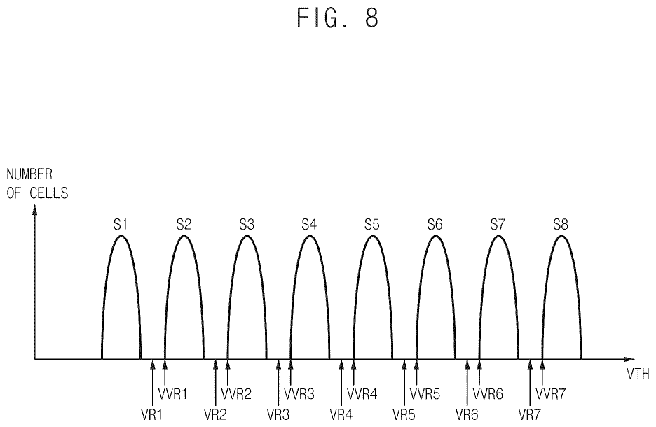

FIG. 8 is a diagram illustrating example states of multi-level cells included in a nonvolatile memory device according to example implementations.

FIG. 8 illustrates first through eighth states S1˜S8 of a triple level cell (TLC) memory where each memory cell of the TLC memory may store three data bits. In FIG. 8, the horizontal axis represents a threshold voltage VTH of memory cells and the vertical axis represents the number of the memory cells corresponding to the threshold voltage VTH. During the program operation, the program success of the first through eighth states S1˜S8 may be distinguished by respectively applying first through seventh verification read voltage VVR1˜VVR7 to the selected wordline. In addition, during the normal read operation, the first through eighth states S1˜S8 may be distinguished by applying at least a portion of first through seventh normal read voltages VR1˜VR7 corresponding to hard-decision read voltages to the selected wordline.

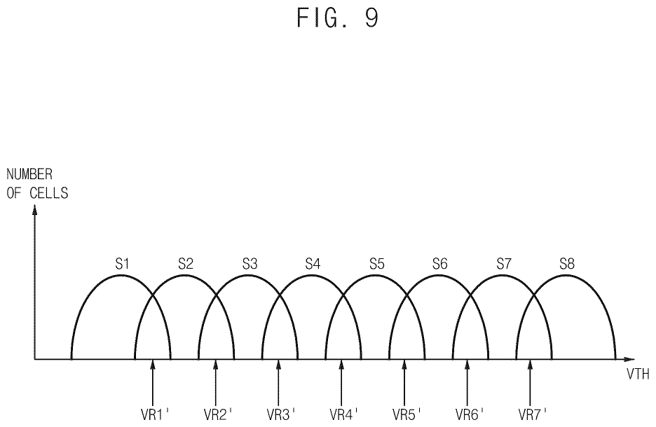

FIG. 9 is a diagram illustrating degenerated states from the states of FIG. 8.

The threshold voltage distributions with respect to the states S1˜S8 of FIG. 8 may be degenerated as illustrated in FIG. 9. During or after programming of memory cells, the intended distributions may be undesirably distorted due to a number of events or conditions including, e.g., charge leakage, program disturbances, read disturbances, wordline and/or bitline coupling, temperature change, voltage change, degeneration of the memory cells, etc. For example, the intended distributions may be shifted and/or broadened.

According to the degeneration degree of the memory cells, the read operation based on the read voltages VR1˜VR7 in FIG. 8 may cause a read fail such that wrong data different from the stored data are read out. When the read fail occurs, the nonvolatile memory device may perform a recovery read operation such that the optimal read voltages VR1′˜VR7′ as illustrated in FIG. 9 are searched to try another read operation based on the optimal read voltages VR1′˜VR7′. However, if the degeneration degree is serious, it may be impossible to discern the states S1˜S7 even by the optimal read voltages VR1′˜VR7′. In addition, obtaining the optimal read voltages VR1′˜VR7′ may take a long time, thereby degrading the performance of the memory system.

According to example implementations, the latency of error correction may be reduced and the correction efficiency may be improved by omitting hard-decision ECC decoding in cases of high error probability and performing soft-edge ECC decoding as described below.

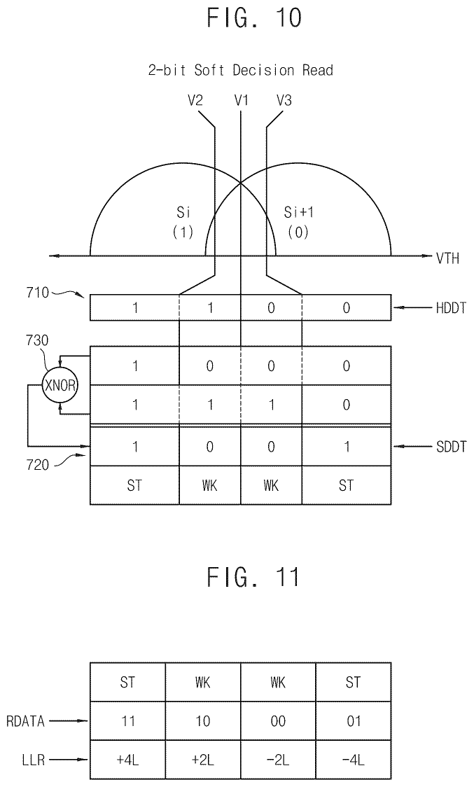

FIG. 10 is a diagram illustrating an example of a 2-bit soft-decision read operation of a nonvolatile memory device included in a memory system according to example implementations.

Referring to FIG. 10, the threshold voltages VTH of the memory cells may be changed due to various factors and thus the two adjacent states Si and Si+1 or the two adjacent threshold voltage distributions Si and Si+1 may be superimposed. The change of the threshold voltages VTH may be caused by interference between the memory cells, program disturbance, read disturbance, charge leakage, etc.

As illustrated in FIG. 10, the nonvolatile memory device may perform a 2-bit soft-decision read operation. The 2-bit soft-decision read operation may include three read operations using three voltages V1, V2 and V3 having regular intervals. For example, the three voltages V1, V2 and V3 may include a first voltage V1 having a desired and/or alternatively predetermined reference level for distinguishing between a first state Si corresponding to data ‘l’ and a second state Si+1 corresponding to data ‘0’, a second voltage V2 lower by a desired and/or alternatively predetermined level than the first voltage V1, and a third voltage V3 higher by the desired and/or alternatively predetermined level than the first voltage V1. In some example implementations, data 710 read by using the first voltage V1 having the reference level may be hard-decision data HDDT 710 read by a hard-decision read operation, and the 2-bit soft-decision read operation may use the hard-decision data 710 read by the hard-decision read operation without applying the first voltage V1 having the reference level. The 2-bit soft-decision read operation may generate soft-decision data SDDT 720 having reliability information for the hard-decision data 710 by performing a desired and/or alternatively predetermined logical operation (e.g., an XNOR operation 730) (or encoding) on data read by using the second voltage V2 and data read by using the third voltage V3. Each bit of the soft-decision data 720 may represent a degree of reliability of a corresponding bit of the hard-decision data 710. For example, a bit of the soft-decision data 720 having a value of ‘1’ may represent that a corresponding bit of the hard-decision data 710 has strong (ST) reliability, and a bit of the soft-decision data 720 having a value of ‘0’ may represent that a corresponding bit of the hard-decision data 710 has weak (WK) reliability.

FIG. 11 is a diagram illustrating an example of a log likelihood ratio (LLR) corresponding to the 2-bit soft-decision read operation of FIG. 10.

Referring to FIG. 11, the first bit of the read data RDATA may correspond to the hard-decision data and the second bit of the read data RDATA may correspond to the soft-decision data. The hard-decision data may be the read bit and the soft-decision data may indicate the reliability. As described with reference to FIGS. 10, a bit of the soft-decision data having a value of ‘1’ may represent that a corresponding bit of the hard-decision data has strong (ST) reliability, and a bit of the soft-decision data having a value of ‘0’ may represent that a corresponding bit of the hard-decision data has weak (WK) reliability.

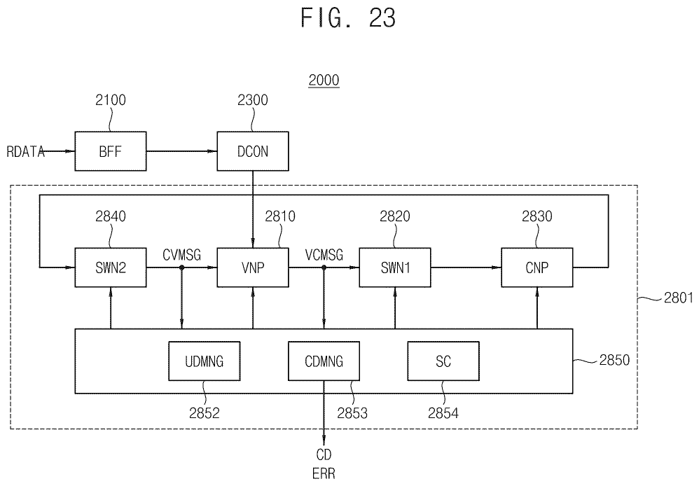

The LLR generator LGEN included in a data converter 2300 as will be described below with reference to FIG. 23 may generate a plurality of LLRs respectively corresponding to the plurality of read pages PG1, PG2 and PG3 based on the read bits and the corresponding reliability.

For example, the LLR may be defined as Expression 1. The definition of the LLR is not limited to Expression 1 and the LLR may be defined by the different method.

$$LLR ( Y ) = C * log \{ P ( Y \vert X = 1 ) / P ( Y \vert X = 0 ) \} \qquad Expression 1$$

In Expression 1, Y indicates a read bit that is read from a memory cell, X indicates a write bit that has been programmed or written in the memory cell, and C indicates a normalization constant. As a result, the positive value of the LLR may represent that the read bit may be 1 with a higher probability than 0. In contrast, the negative value of the LLR may represent that the read bit may be 0 with a higher probability than 1.

FIG. 11 illustrates an example of mapping between the read data RDATA and the LLR. In FIG. 11, L indicates a positive value which may be set to a proper value according to a decoding scheme. The LLR of +4L indicates the bit value of 1 with ST reliability, the LLR of +2L indicates the bit value of 1 with WK reliability, LLR of −4L indicates the bit value of 0 with ST reliability, and the LLR of −2L indicates the bit value of 0 with WK reliability. The mapping of FIG. 11 is just an example, and example implementations are limited thereto.

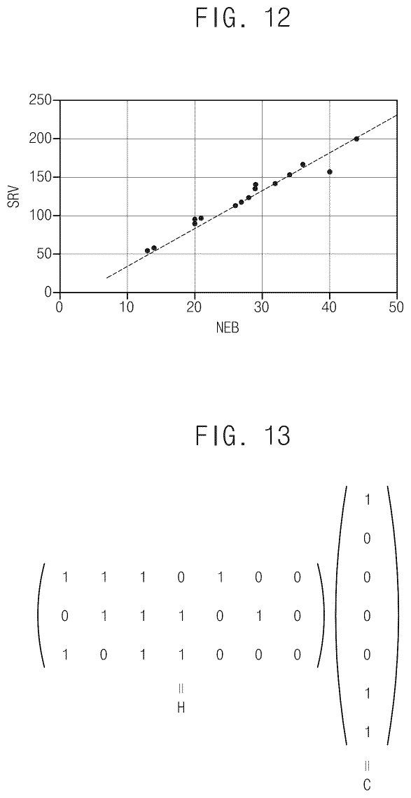

FIG. 12 is a diagram illustrating a relationship between a number of error bits and a syndrome result value with respect to read data of a nonvolatile memory device, and FIG. 13 is a diagram for describing operation of an on-chip syndrome checker included in a nonvolatile memory device according to example implementations.

FIG. 12 illustrates the result of LDPC decoding as an example. As shown in FIG. 12, the number of error bits (NEB) in the hard-decision data HDDT is schematically linearly related to the syndrome result value SRV. Based on the operational characteristics of the nonvolatile memory device 300, the degraded state of the memory cells, and the correction capability of the ECC decoder DEC, a threshold value TH of the syndrome result value SRV may be determined, such that there is a significant likelihood that the hard-decision ECC decoding will fail when the syndrome result value SRV is below the threshold value TH.

The syndrome is information that determines whether a certain encoding rule has been violated, and the syndrome checker provides a syndrome result value SRV that allows the syndrome checker to determine whether an error has occurred or to predict the extent of the error even before performing ECC decoding.

FIG. 13 illustrates a syndrome calculation for a Hamming code as an example. Referring to FIG. 13, the on-chip syndrome checker OSC described above may provide a syndrome result value S by performing the calculation of Expression 2 on the codeword matrix H and the parity check vector C to provide the syndrome result value S.

$$\begin{matrix}{S}_{i} = {MOD}_{2} \{ {\sum }_{j = 0}^{j = max} ( {H}_{ij} * {c}_{j} ) \} \\ S = {\sum }_{i = 0}^{i = max} {s}_{i}\end{matrix} \qquad Expression 2$$

In Expression 2, Hᵢⱼ represents the components of the i-th row and j-th column of the codeword matrix H and Cj represents the components of the j-th row of the parity check vector C. MOD₂ represents the remainder divided by 2.

As such, the on-chip syndrome checker OSC may be implemented as a relatively simple arithmetic circuit that performs multiplication and addition operations. By integrating and utilizing the on-chip syndrome checker OSC, which is significantly smaller in size than the ECC decoder DEC included in the memory controller 100, into the nonvolatile memory device 300, the performance of the nonvolatile memory device 300 may be efficiently improved without degrading the design margin of the nonvolatile memory device 300.

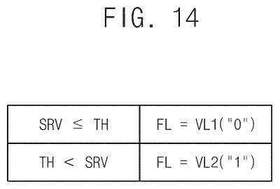

FIG. 14 is a diagram illustrating example implementations of generating a flag based on a syndrome result value in a memory system according to example implementations.

Referring to FIGS. 1 and 14, the nonvolatile memory device 300 or the memory controller 100 may generate a flag FL by comparing the syndrome result value SRV with the threshold value TH. The nonvolatile memory device 300 or the memory controller 100 may generate the flag FL to have a first value VL1 when the syndrome result value SRV is not greater than the threshold value TH and a second value VL2 when the syndrome result value SRV is greater than the threshold value TH. For example, the flag FL may have a value of one bit. In this case, the first value VL1 may correspond to a value of “0” and the second value VL2 may correspond to a value of “1”, but example implementations are not limited thereto.

FIGS. 15, 16 and 17 are flowcharts illustrating operation of a memory system according to example implementations.

Referring to FIG. 15, the memory controller 100 may receive a read request RREQ from an external host device (S11) and may transfer a read command RD to the nonvolatile memory device 300 based on the read request RREQ (S12).

The nonvolatile memory device 300 may sequentially read out and store hard-decision data HDDT and soft-decision data SDDT from the memory cell array based on one read command RD transferred from the memory controller 100 (S13, S14).

The on-chip syndrome checker OSC of the nonvolatile memory device 300 may generate a syndrome result value SRV (S15) by calculating the syndrome of the hard-decision data HDDT. The control circuit (e.g., the control circuit 550 of FIG. 4) of the nonvolatile memory device 300 may generate a flag FL based on the syndrome result value SRV (S16). For example, as described above with reference to FIG. 14, the control circuit 550 may generate the flag FL having the first value VL1 when the syndrome result value SRV is not greater than the threshold value TH and the second value VL2 when the syndrome result value SRV is greater than the threshold value TH.

The nonvolatile memory device 300 may transfer the flag FL to the memory controller 100 (S17), and the memory controller 100 may control ECC decoding based on the flag FL.

When the flag FL has the first value VL1 (S18: VL1), the memory controller 100 may transfer a first transmission command TRH to the nonvolatile memory device 300 (S19), and the nonvolatile memory device 300 may transfer the hard-decision data HDDT excluding the soft-decision data SDDT to the memory controller 100 (S20), based on receiving the first transmission command TRH. The ECC decoder DEC of the memory controller 100 may perform the hard-decision ECC decoding based on the transferred hard-decision data HDDT (S21).

On the other hand, when the flag FL has the second value VL2 (S18: VL2), the memory controller 100 may transfer a second transmission command TRS to the nonvolatile memory device 300 (S22), and the nonvolatile memory device 300 may transfer hard-decision data HDDT and soft-decision data SDDT to the memory controller 100 (S23), based on receiving the second transmission command TRS. The ECC decoder DEC of the memory controller 100 may perform the soft-decision ECC decoding based on the transferred hard-decision data HDDT and the transferred soft-decision data SDDT (S24).

Referring to FIG. 16, the memory controller 100 may receive a read request RREQ from an external host device (S31) and may transfer a read command RD to the nonvolatile memory device 300 based on the read request RREQ (S32).

The nonvolatile memory device 300 may sequentially read out and store the hard-decision data HDDT and the soft-decision data SDDT from the memory cell array based on one read command RD transferred from the memory controller 100 (S33, S34).

The on-chip syndrome checker OSC of the nonvolatile memory device 300 may generate a syndrome result value SRV (S35) by calculating the syndrome of the hard-decision data HDDT. The control circuit (e.g., the control circuit 550 of FIG. 4) of the nonvolatile memory device 300 may generate a flag FL based on the syndrome result value SRV (S36). For example, as described above with reference to FIG. 14, the control circuit 550 may generate the flag FL having the first value VL1 when the syndrome result value SRV is not greater than the threshold value TH and the second value VL2 when the syndrome result value SRV is greater than the threshold value TH.

When the flag FL has the first value VL1 (S37: VL1), the control circuit 550 of the nonvolatile memory device 300 may transfer the flag FL and the hard-decision data HDDT to the memory controller 100 to the memory controller 100 (S38). The ECC decoder DEC of the memory controller 100 may perform hard-decision ECC decoding based on the transferred hard-decision data HDDT (S39).

On the other hand, when the flag FL has the second value VL2 (S37: VL2), the control circuit 550 of the nonvolatile memory device 300 may transfer the flag FL, the hard-decision data HDDT, and the soft-decision data SDDT to the memory controller 100 (S40). The ECC decoder DEC of the memory controller 100 may perform the soft-decision ECC decoding based on the transferred hard-decision data HDDT and soft-decision data SDDT (S41).

Referring to FIG. 17, the memory controller 100 may receive a read request RREQ from an external host device (S51) and transfer a read command RD to the nonvolatile memory device 300 based on the read request RREQ (S52).

The nonvolatile memory device 300 may sequentially read out and store the hard-decision data HDDT and the soft-decision data SDDT from the memory cell array based on one read command RD transferred from the memory controller 100 (S53, S54).

The on-chip syndrome checker OSC of the nonvolatile memory device 300 may generate a syndrome result value SRV (S55) by calculating the syndrome of the hard-decision data HDDT, and transfer the syndrome result value SRV to the memory controller 100 (S56).

The processor (e.g., the processor 110 of FIG. 3) of the memory controller 100 may generate a flag FL based on the syndrome result value SRV (S57). For example, as described above with reference to FIG. 14, the processor 110 may generate the flag FL having the first value VL1 when the syndrome result value SRV is not greater than a threshold value TH and the second value VL2 when the syndrome result value SRV is greater than the threshold value TH.

When the flag FL has the first value VL1 (S58: VL1), the memory controller 100 may transfer a first transmission command TRH to the nonvolatile memory device 300 (S59), and the nonvolatile memory device 300 may transfer the hard-decision data HDDT excluding soft-decision data SDDT to the memory controller 100 based on receiving the first transmission command TRH (S60). The ECC decoder DEC of the memory controller 100 may perform the hard-decision ECC decoding based on the transferred hard-decision data HDDT (S61).

On the other hand, when the flag FL has the second value VL2 (S58: VL2), the memory controller 100 may transfer a second transmission command TRS to the nonvolatile memory device 300 (S62), and the nonvolatile memory device 300 may transfer the hard-decision data HDDT and the soft-decision data SDDT to the memory controller 100 based on receiving the second transmission command TRS (S63). The ECC decoder DEC of the memory controller 100 may perform the soft-decision ECC decoding based on the transferred hard-decision data HDDT and the transferred soft-decision data SDDT (S64).

As described with reference to FIGS. 15, 16, and 17, the ECC decoder DEC of the memory controller 100 may, depending on the syndrome result value SRV, perform the hard-decision ECC decoding based on hard-decision data HDDT or perform the soft-decision ECC decoding based on hard-decision data HDDT and the soft-decision data SDDT by omitting the hard-decision ECC decoding.

When the syndrome result value SRV is greater than the threshold value TH, the nonvolatile memory device 300 may transfer the hard-decision data HDDT and the soft-decision data SDDT to the memory controller 100, and the ECC decoder DEC of the memory controller 100 may perform soft-decision ECC decoding based on the received hard-decision data HDDT and the received soft-decision data SDDT. When the syndrome result value SRV is not greater than the threshold value TH, the nonvolatile memory device 300 may transfer the hard-decision data HDDT excluding the soft-decision data SDDT to the memory controller 100, and the ECC decoder DEC of the memory controller 100 may perform the hard-decision ECC decoding based on the received hard-decision data HDDT.

FIG. 18 is a diagram illustrating an example of a partitioning of hard-decision data corresponding to a page.

Referring to FIG. 18, the hard-decision data HDDT corresponding to one page, which is the unit of the write operation and the read operation of the nonvolatile memory device, may be divided into a plurality of sub-hard-decision data HDDT1 through HDDT4, which is the unit of the ECC decoding. For each of the plurality of sub-hard-decision data HDDT1 through HDDT4, a plurality of syndrome result values SRV1 through SRV4 and a plurality of flags FL1 through FL4 may be generated in the same manner as described above. While FIG. 18 illustrates an example of dividing the hard-decision data HDDT into the four sub-hard-decision data for convenience of illustration and description, example implementations are not limited thereto. Also, the soft-decision data SDDT may be divided into a plurality of sub-soft-decision data SDDT1 through SDDT4 corresponding to the plurality of sub-hard-decision data HDDT1 through HDDT2.

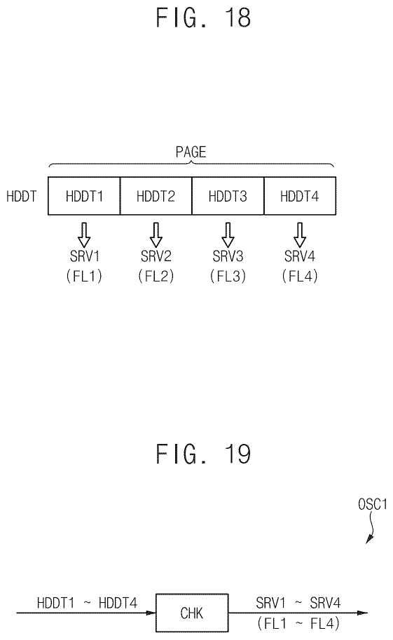

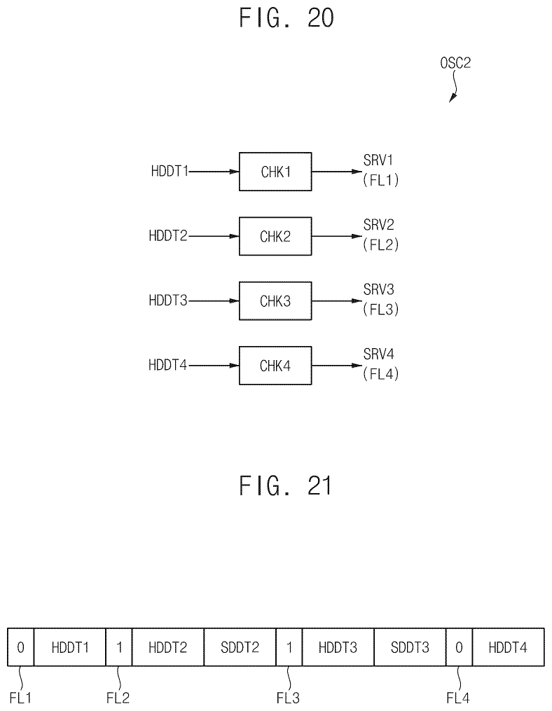

FIGS. 19 and 20 are diagrams illustrating example implementations of an on-chip syndrome checker included in a nonvolatile memory device according to example implementations.

Referring to FIGS. 19 and 20, on-chip syndrome checkers OSC1 and OSC2 may receive a plurality of sub-hard-decision data, e.g., first through fourth sub-hard-decision data HDDT1 through HDDT4, and generate first through fourth syndrome result values SRV1 through SRV4 corresponding to the first through fourth sub-hard-decision data HDDT1 through HDDT4 by calculating syndromes for each of the first through fourth sub-hard-decision data HDDT1 through HDDT4, respectively. According to example implementations, the on-chip syndrome checkers OSC1 and OSC2 may compare the first through fourth syndrome result values SRV1 through SRV4 with a threshold value TH to generate first through fourth flags FL1 through FL4 corresponding to the syndrome result values SRV1 through SRV4, respectively.

In an example embodiment, as shown in FIG. 19, the on-chip syndrome checker OSC1 may include one syndrome checker CHK configured to sequentially generate the first through fourth syndrome result values SRV1 through SRV4 or the first through fourth flags FL1 through FL4.

In an example embodiment, as shown in FIG. 20, the on-chip syndrome checker OSC2 may include four syndrome checkers CHK1 through CHK4 configured to, in parallel, generate the first through fourth syndrome result values SRV1 through SRV4 or the first through fourth flags FL1 through FL4.

FIG. 21 is a diagram illustrating an example implementation of transferring read data in a memory system according to example implementations.

Referring to FIG. 21, for example, the first flag FL1 corresponding to the first sub-hard-decision data HDDT1 and the fourth flag FL4 corresponding to the fourth sub-hard-decision data HDDT4 may have the first value (e.g., a value of “0”), whereas the second flag FL2 corresponding to the second sub-hard-decision data HDDT2 and the third flag FL3 corresponding to the third sub-hard-decision data HDDT3 may have the second value (e.g., a value of “1”).

In this case, the nonvolatile memory device 300 may sequentially transfer the read data corresponding to the value of each flag to the memory controller 100. In other words, the nonvolatile memory device 300 may transfer the first sub-hard-decision data HDDT1 with the first flag FL1, the second sub-hard-decision data HDDT2 and the second sub-soft-decision data SDDT2 with the second flag FL2, the third sub-hard-decision data HDDT3 and the third sub-soft-decision data SDDT3 with the third flag FL3, and the fourth sub-hard-decision data HDDT4 with the fourth flag FL4.

When each syndrome result value SRVi (i=1, 2, 3, 4) of the plurality of syndrome result values SRV1 through SRV4 is not greater than the threshold value TH, the nonvolatile memory device 300 may transfer the sub-hard-decision data HDDTi corresponding to each syndrome result value SRVi to the memory controller 100. The ECC decoder DEC of the memory controller 100 may perform the hard-decision ECC decoding based on the sub-hard-decision data HDDTi.

On the other hand, when each syndrome result value SRVi is greater than the threshold value TH, the nonvolatile memory device 300 may transfer the sub-hard-decision data HDDTi and the sub-soft-decision data SDDTi corresponding to the sub-hard-decision data HDDTi to the memory controller 100. The memory controller 100 may perform the soft-decision ECC decoding based on the sub-hard-decision data HDDTi and the sub-soft-decision data SDDTi.

As such, based on the plurality of syndrome result values, with respect to each of the plurality of sub-hard-decision data, the hard-decision ECC decoding may be performed, or the soft-decision ECC decoding may be performed by omitting the hard-decision ECC decoding.

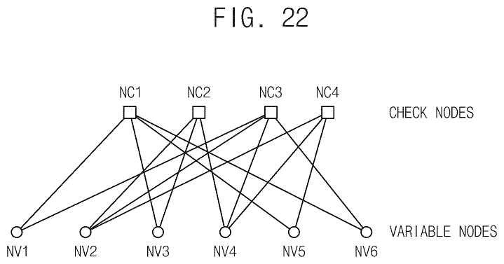

Referring now to FIGS. 22 and 23, an example of ECC decoding is described, but example implementations are not limited to any particular ECC scheme.

FIG. 22 is a diagram illustrating a low-density parity check code for error correction in a memory system according to example implementations.

Low-density parity-check (LDPC) codes are one type of codes that have a correction capacity that is close to the channel capacity, and because of this superior correction capacity, the LDPC codes are widely used in communication systems, communication standards, controllers for memory, and the like. The LDPC codes are linear block codes and may be defined as a parity check matrix (PCM). The definition of code here is the relationship between information and parity.

FIG. 22 shows an example of a Tanner graph. The Tanner graph includes variable nodes NV1 through NV6, check nodes NC1 through NC4, and edges connecting them. The number of variable nodes and the number of check nodes may be varied. The variable nodes NV1 through NV6 are associated with bits of the codeword and the check nodes NC1 through NC4 are associated with parity-check constraints. The “1” component of the PCM corresponds to an edge in the Tanner graph. The number of edges connected to each node is defined by the degree of the node.

FIG. 23 is a block diagram illustrating an ECC decoder according to example implementations.

Referring to FIG. 23, an ECC decoder 2000 may include a buffer BFF 2100, a data converter DCON 2300 and a decoding circuit 2801.

The buffer 2100 may store read data RDATA read from a memory device. As described above, the buffer 2100 may store a plurality of read pages read from a plurality of multi-level cells connected to a same wordline. The read data RDATA may include hard-decision data and soft-decision data.

When a hard-decision is conducted, the buffer 2100 receives the hard-decision data that are read using a normal read voltage from the memory device and stores the received data. The stored data may be provided to the data converter 2300 for the decoding operation. When a soft-decision is conducted, the buffer 2100 receives the soft-decision data that are read using a partial read voltage from the memory device in addition to the hard-decision data and stores the received data. The partial read voltage means a voltage that is proximate to the normal read voltage but has a different voltage level than the normal read voltage. The hard-decision data and the soft-decision data stored in the buffer 2100 may be provided to the data converter 2300 for the decoding operation. The hard-decision data and the soft-decision data are the same as described above with reference to FIGS. 10 and 11.

The data converter 2300 may be configured to map the LLR values to the provided read data. In some example implementations, the data converter 2300 may include a hard-decision LLR register storing LLR values to be mapped during a hard-decision and a soft-decision LLR register storing LLR values to be mapped during the soft-decision.

During the hard-decision, the data converter 2300 receives the hard-decision data from the buffer 2100. The data converter 2300 maps the hard-decision data with corresponding LLR values according to each bit value of the hard-decision data. During the soft-decision, the data converter 2300 receives the hard-decision data and the soft-decision data from the buffer 2100. The data converter 2300 maps the hard-decision data with corresponding LLR values according to each bit value of the soft-decision data. During the hard-decision or the soft-decision, a result of the mapping carried out by the data converter 2300 is output to the decoding circuit 2801 as LLR data.

The decoding circuit 2801 performs LDPC decoding on the received LLR data. During the hard-decision and the soft-decision, respective LLR data may be LDPC-decoded using the same method and device. The decoding circuit 2801 updates check nodes and variable nodes according to a parity check matrix during the LDPC decoding. The decoding circuit 2801 performs provisional decoding according to a result of the update (e.g., a posteriori probability) and computes the provisionally decoded data and the parity check matrix to determine whether decoding is correctly performed according to a result of the computation.

For example, if the result of computation with the parity check matrix is a zero matrix, it is determined that the decoding is correctly performed. If the result is not a zero matrix, it is determined that the decoding is not correctly performed. If the decoding is correctly performed, the decoding circuit 2801 outputs the decoded data as decoded data CD. If the decoding is not correctly performed (e.g., all errors of the read data are not corrected), the decoding circuit 2801 re-updates the check nodes and the variable nodes.

The above update and provisional decoding of check nodes and variable nodes are iteratively performed. The update and provisional decoding of check nodes and variable nodes may constitute a single decoding loop, that is, a decoding iteration. When the hard-decision is conducted in the decoding circuit 2801 and parity check based on the hard-decision fails, the decoding circuit 2801 transmits a fail message ERR.

The decoding circuit 2801 may include a variable node processor VNP 2810, a first switch network SWN1 2820, a check node processor CNP 2830, a second switch network SWN2 2840, and a controller 2850. The controller 2850 may include an update manager UDMNG 2852, a corrected data manager CDMNG 2853 and a syndrome checker SC 2854.

During the LDPC decoding, a nonzero element in the parity check matrix means that a corresponding variable node and a corresponding check node are connected to each other. The decoding is performed through data transmitted according to the connection of the variable node and the check node.

The variable node processor 2810 stores the provided LLR data from the data converter 2300 and provides the stored LLR data, as a variable node message VCMSG, to the check node processor 2830 through the first switch network 2820.

The check node processor 2830 compares values of variable nodes with respect to each check node with reference to the provided variable node message VCMSG to provide a check node message CVMSG. The check node message CVMSG provided to the variable node processor 2810 through the second switch network 2840.

The variable node processor 2810 updates values of the variable and check nodes with reference to the received check node message CVMSG. The variable node processor 2810 performs decoding according to the updated values of the variable and check nodes. A result of the decoding is provided to the corrected data manager 2853 as decoding data.

The corrected data manager 2853 stores the result of the decoding performed in the variable node processor 2810 and outputs the corrected data CD or a read error message ERR to an external device depending on whether decoding of the syndrome checker 2854 is successfully performed.

The syndrome checker 2854 determines whether the decoding is successfully performed, according to the decoding data stored in the corrected data manager 2853. For example, the syndrome checker 2854 multiplies the decoding data by a transpose matrix of the parity check matrix and determines whether the decoding is successfully performed (or whether all errors are corrected) depending on whether a result of the multiplication is a zero matrix. The syndrome checker 2854 provides a result of the determination to the corrected data manager 2853.

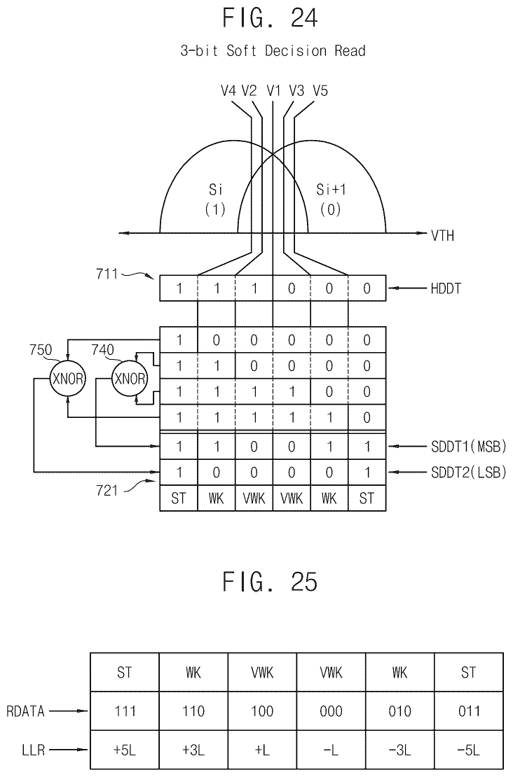

FIG. 24 is a diagram illustrating an example of a 3-bit soft-decision read operation of a nonvolatile memory device included in a memory system according to example implementations.

As illustrated in FIG. 24, the nonvolatile memory device may perform a 3-bit soft-decision read operation. The 3-bit soft-decision read operation may include five read operations using five voltages V1, V2, V3, V4 and V5 having regular intervals. For example, the first through fifth voltages V1, V2, V3, V4 and V5 may include the three voltages V1, V2 and V3 used in the 2-bit soft-decision read operation, and may further include a fourth voltage V4 lower than the second voltage V2 and a fifth voltage V5 higher than the third voltage V3. In some example implementations, the data 711 read by using the first voltage V1 may be the hard-decision data HDDT read by the hard-decision read operation. The data read by using the second through fifth voltages V2˜V5 may be used to obtain the soft-decision data 721. The soft-decision data 721 may include a most significant bit (MSB) SDDT1 and a least significant bit (LSB) SDD2, which may be obtained by performing desired and/or alternatively predetermined logical operations (e.g., XNOR operations 740 and 750) (or encoding) on data read by using the second through fourth voltages V2˜V4. Each bit pair of the soft-decision data 721 having two bits may represent a degree of reliability of a corresponding bit of the hard-decision data 711. For example, each soft-decision bit pair having a value of ‘11’ may represent that a corresponding bit of the hard-decision data has strong (VS) reliability, each soft-decision bit pair having a value of ‘10’ may represent that a corresponding bit of the hard-decision data has intermediate (WK) reliability, and each soft-decision bit pair having a value of ‘00’ may represent that a corresponding bit of the hard-decision data has weak (VWK) reliability.

FIG. 25 is a diagram illustrating an example of an LLR corresponding to the 3-bit soft-decision read operation of FIG. 24.

Referring to FIG. 25, the first bit of the read data RDATA may correspond to the hard-decision data and the second and third bits of the read data RDATA may correspond to the soft-decision data. The hard-decision data may be the read bit and the soft-decision data may indicate the reliability of the hard-decision data. As described with reference to FIGS. 24, a bit pair of the soft-decision data having a value of ‘11’ may represent that a corresponding bit of the hard-decision data has strong (ST) reliability, a bit pair of the soft-decision data having a value of ‘10’ may represent that a corresponding bit of the hard-decision data has intermediate (WK) reliability, and a bit pair of the soft-decision data having a value of ‘00’ may represent that a corresponding bit of the hard-decision data has weak (VWK) reliability

FIG. 25 illustrates an example of mapping between the read data RDATA and the LLR. In FIG. 25, L indicates a positive value which may be set to a proper value according to a decoding scheme. The LLR of +5L indicates the bit value of 1 with ST reliability, the LLR of +3L indicates the bit value of 1 with WK reliability, the LLR of +L indicates the bit value of 1 with VWK reliability, LLR of −5L indicates the bit value of 0 with ST reliability, the LLR of −3L indicates the bit value of 0 with WK reliability, and the LLR of −L indicates the bit value of 0 with VWK reliability.

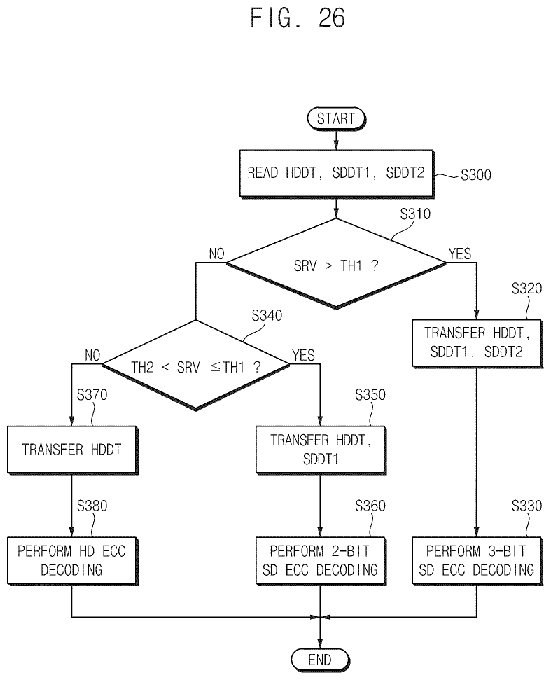

FIG. 26 is a flowchart illustrating a method of operating a memory system according to example implementations.

Referring to FIGS. 1 and 26, the nonvolatile memory device 300 may sequentially read out and store the hard-decision data HDDT, the most significant bit SDDT1 of the soft-decision data SDDT, and the least significant bit SDDT2 of the soft-decision data SDDT from the memory cell array of the nonvolatile memory device 300 based on one read command transferred from the memory controller 100 (S300).

By the on-chip syndrome checker OSC included in the nonvolatile memory device 300, the syndrome of the soft-decision data may be calculated to generate the syndrome result value SRV. In an example embodiment, as described above with reference to FIG. 17, the nonvolatile memory device 300 may provide the syndrome result value SRV to the memory controller 100 as the syndrome information SDI. In another example embodiment, as described above with reference to FIGS. 15 and 16, the nonvolatile memory device 300 may generate the flag FL based on the syndrome result value SRV and provide the flag FL to the memory controller 100 as the syndrome information SDI.

Based on the syndrome result value SRV, the memory controller 100 may perform the hard-decision ECC decoding based on the hard-decision data HDDT, or may perform a 2-bit soft-decision ECC decoding based on the hard-decision data HDDT and the most significant bit SDDT1 of the soft-decision data SDDT by omitting the hard-decision ECC decoding, and perform a 3-bit soft-decision ECC decoding based on the hard-verdict data HDDT, and the most and least significant bits SDDT1 and SDDT2 of the soft-verdict data SDDT1 by omitting the hard-verdict ECC decoding.

According to example implementations, the nonvolatile memory device 300 or the memory controller 100 may compare the syndrome result value SRV with a first threshold value TH1 (S310).

When the syndrome result value SRV is greater than the first threshold value TH1 (S310: YES), the nonvolatile memory device 300 may transfer the hard-decision data HDDT, the high bit SDDT1 of the soft-decision data and the least significant bit SDDT2 of the soft-decision data to the memory controller 100 (S320), the ECC decoder DEC may perform the 3-bit soft-decision (SD) ECC decoding based on the hard-decision data HDDT, the most significant bit SDDT1 and the least significant bit SDDT2 (S330).

When the syndrome result value SRV is not greater than (i.e., less than or equal to) the first threshold value TH1 (S310: NO), the nonvolatile memory device 300 or the memory controller 100 may compare the syndrome result value SRV with a second threshold value TH2 (S340).

When the syndrome result value SRV is not greater than the first threshold value TH1 and greater than the second threshold value TH2 (S340: YES), the nonvolatile memory device 300 may transfer the hard-decision data HDDT and the high bit SDDT1 of the soft-decision data to the memory controller 100 excluding the least significant bit SDDT2 of the soft-decision data (S350), and the ECC decoder DEC may perform the 2-bit soft-decision (SD) ECC decoding based on the hard-decision data HDDT and the most significant bit SDDT1 (S360).

When the syndrome result value SRV is not greater than (i.e., less than or equal to) the second threshold value TH2 (S340: NO), the nonvolatile memory device 300 may transfer the hard-decision data HDDT excluding the soft-decision data SDDT1 and SDDT2 to the memory controller 100 (S370). The ECC decoder DEC may perform the hard-decision (HD) ECC decoding based on the hard-decision data HDDT (S380).

As such, the nonvolatile memory device 300, the memory system 10, and the method of operating the memory system 10 according to example implementations may further refine the range of the syndrome result value SRV to selectively perform the hard-decision ECC decoding, the 2-bit soft-decision ECC decoding, or the 3-bit soft-decision ECC decoding to further increase the probability of successful error correction, thereby reducing the latency of ECC decoding and improving the performance of the nonvolatile memory device 300 and the memory system 10.

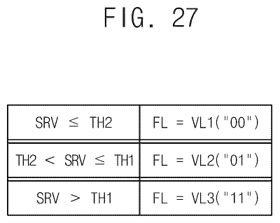

FIG. 27 is a diagram illustrating an example implementation of generating a flag based on a syndromic result value in a memory system according to example implementations.

Referring to FIGS. 1 and 27, the nonvolatile memory device 300 or the memory controller 100 may generate the flag FL by comparing the syndrome result value SRV with the first threshold value TH1 and the second threshold value TH2. The nonvolatile memory device 300 or the memory controller 100 may have the first value VL1 when the syndrome result value SRV is less than or equal to the second threshold value TH2, the second value VL2 when the syndrome result value SRV is less than or equal to the first threshold TH1 and greater than the second threshold TH2, and the third value VL1 when the syndrome result value SRV is greater than the first threshold TH1. For example, the flag FL may be a two-bit value. In this case, the first value VL1 may correspond to a value of “00”, the second value VL2 may correspond to a value of “01”, and the third value VL3 may correspond to a value of “11”, but example implementations are not limited thereto.

FIG. 28 is a diagram for describing a fabrication process of a stacked semiconductor device according to example implementations.

Referring to FIG. 28, a first wafer WF1 and a second wafer WF2 are formed with respective integrated circuits. The first wafer WF1 may include the memory cell array as described above formed on it, and the second wafer WF2 may have peripheral circuits as described above formed on it.

With the integrated circuits of the first wafer WF1 and the second wafer WF2 formed, the first wafer WF1 and the second wafer WF2 are bonded by a bonding method. The bonded wafers WF1 and WF2 are cut into a plurality of chips, each of which corresponds to a semiconductor device 3000 including stacked semiconductor dies SD1 and SD2. The cut portion of the first wafer WF1 corresponds to the first semiconductor die SD1, and the cut portion of the second wafer WF2 corresponds to the second semiconductor die SD2. The nonvolatile memory device according to example implementations may be manufactured by the bonding method of FIG. 28.

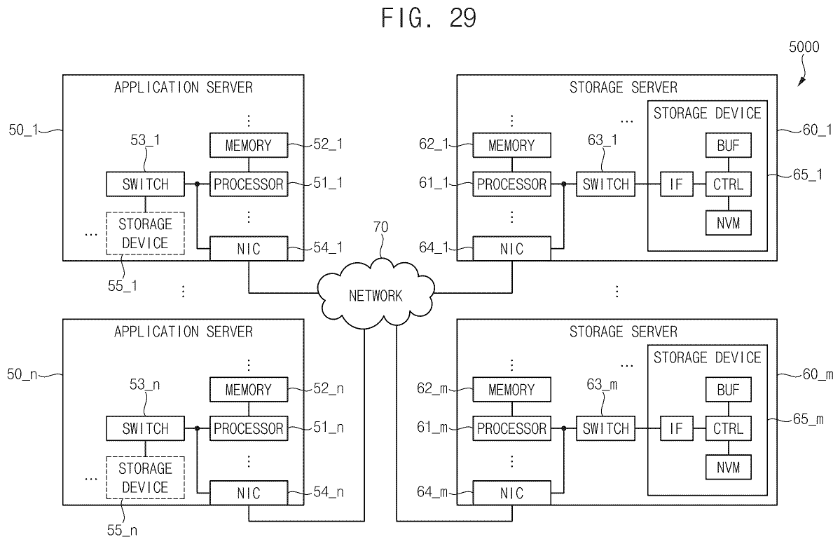

FIG. 29 is a block diagram illustrating a data center including a storage device according to example implementations.

In some example implementations, the memory system described above with reference to FIGS. 1-18 may serve as an application server and/or a storage server and may be included in a data center 5000.

Referring to FIG. 29, the data center 5000 may collect various pieces of data and provide services and be also referred to as a data storage center. For example, the data center 5000 may be a system configured to operate a search engine and a database or a computing system used by companies, such as banks, or government agencies. As shown in FIG. 29, the data center 5000 may include application servers 50_1 to 50_n and storage servers 60_1 to 60_m(where, each of m and n is an integer more than 1). The number n of application servers 50_1 to 50_n and the number m of storage servers 60_1 to 60_m may be variously selected according to example implementations. In some example implementations, the number n of application servers 50_1 to 50_n may be different from the number m of storage servers 60_1 to 60_m.

The application servers 50_1 to 50_n may include any one or any combination of processors 51_1 to 51_n, memories 52_1 to 52_n, switches 53_1 to 53_n, network interface controllers (NICs) 54_1 to 54_n, and storage devices 55_1 to 55_n. The processors 51_1 to 51_n may control all operations of the application servers 50_1 to 50_n, access the memories 52_1 to 52_n, and execute instructions and/or data loaded in the memories 52_1 to 52_n. Non-limiting examples of the memories 52_1 to 52_n may include DDR SDRAM, a high-bandwidth memory (HBM), a hybrid memory cube (HMC), a dual in-line memory module (DIMM), a Optane DIMM, or a nonvolatile DIMM (NVDIIMM).

According to example implementations, the numbers of processors and memories included in the application servers 50_1 to 50_n may be variously selected according to example implementations. In some example implementations, the processors 51_1 to 51_n and the memories 52_1 to 52_n may provide processor-memory pairs. In some example implementations, the number of processors 51_1 to 51_n may be different from the number of memories 52_1 to 52_n. The processors 51_1 to 51_n may include a single core processor or a multi-core processor. In some example implementations, as illustrated with a dashed line in FIG. 29, the storage devices 55_1 to 55_n may be omitted from the application servers 50_1 to 50_n. The number of storage devices 55_1 to 55_n included in the storage servers 50_1 to 50_n may be variously selected according to example implementations. The processors 51_1 to 51_n, the memories 52_1 to 52_n, the switches 53_1 to 53_n, the NICs 54_1 to 54_n, and/or the storage devices 55_1 to 55_n may communicate with each other through a link described above with reference to the drawings.

The storage servers 60_1 to 60_m may include any one or any combination of processors 61_1 to 61_m, memories 62_1 to 62_m, switches 63_1 to 63_m, network interface controllers (NICs) 64_1 to 64_n, and storage devices 65_1 to 65_m. The processors 61_1 to 61_m and the memories 62_1 to 62_m may operate similar to the processors 51_1 to 51_n and the memories 52_1 to 52_n of the application servers 50_1 to 50_n described above.

The application servers 50_1 to 50_n may communicate with the storage servers 60_1 to 60_m through a network 70. In some example implementations, the network 70 may be implemented using a fiber channel (FC) or Ethernet. The FC may be a medium used for relatively high-speed data transfer. An optical switch that provides high performance and high availability may be used as the FC. The storage servers 60_1 to 60_m may be provided as file storages, block storages, or object storages according to an access method of the network 70.

In some example implementations, the network 70 may be a storage-only network, such as a storage area network (SAN). For example, the SAN may be an FC-SAN, which may use an FC network and be implemented using an FC Protocol (FCP). In another case, the SAN may be an Internet protocol (IP)-SAN, which uses a transmission control protocol/Internet protocol (TCP/IP) network and is implemented according to an SCSI over TCP/IP or Internet SCSI (iSCSI) protocol. In some example implementations, the network 70 may be a general network, such as a TCP/IP network. For example, the network 70 may be implemented according to a protocol, such as FC over Ethernet (FCoE), network attached storage (NAS), nonvolatile memory express (NVMe) over fabrics (NVMe-oF).

The application server 50_1 and the storage server 60_1 will mainly be described, but it may be noted that a description of the application server 50_1 may be also applied to another application server (e.g., 50_n), and a description of the storage server 60_1 may be also applied to another storage server (e.g., 60_m).

The application server 50_1 may store data, which is requested to be stored by a user or a client, in one of the storage servers 60_1 to 60_m through the network 70. In some example implementations, the application server 50_1 may obtain data, which is requested to be read by the user or the client, from one of the storage servers 60_1 to 60_m through the network 70. For example, the application server 50_1 may be implemented using a web server or a database management system (DBMS).

The application server 50_1 may access the memory 52_n and/or the storage device 55_n included in another application server 50_n, through the network 70, and/or access the memories 62_1 to 62_m and/or the storage devices 65_1 to 65_m included in the storage servers 60_1 to 60_m, through the network 70. Accordingly, the application server 50_1 may perform various operations on data stored in the application servers 50_1 to 50_n and/or the storage servers 60_1 to 60_m. For example, the application server 50_1 may execute an instruction to migrate or copy data between the application servers 50_1 to 50_n and/or the storage servers 60_1 to 60_m. In this case, the data may be migrated from the storage devices 65_1 to 65_m of the storage servers 60_1 to 60_m to the memories 52_1 to 52_n of the application servers 50_1 to 50_n through the memories 62_1 to 62_m of the storage servers 60_1 to 60_m or directly. In some example implementations, the data migrated through the network 70 may be encrypted data for security or privacy.

In the storage server 60_1, an interface IF may provide physical connection between the processor 61_1 and a controller CTRL and physical connection between the NIC 64_1 and the controller CTRL. For example, the interface IF may be implemented using a direct attached storage (DAS) method in which the storage device 65_1 is directly connected to a dedicated cable. For example, the interface IF may be implemented using various interface methods, such as advanced technology attachment (ATA), serial ATA (SATA), external SATA (e-SATA), small computer small interface (SCSI), serial attached SCSI (SAS), PCI, PCIe, NVMe, IEEE 1394, a universal serial bus (USB), a secure digital (SD) card, a multi-media card (MMC), an embedded MMC (eMMC), a UFS, an embedded UFS (eUFS), and/or a compact flash (CF) card interface.

In the storage server 60_1, the switch 63_1 may selectively connect the processor 61_1 to the storage device 65_1 or selectively connect the NIC 64_1 to the storage device 65_1 based on the control of the processor 61_1.

In some example implementations, the network interface controller (NIC) 64_1 may include a network interface card and a network adaptor. The NIC 54_1 may be connected to the network 70 through a wired interface, a wireless interface, a Bluetooth interface, or an optical interface. The NIC 64_1 may include an internal memory, a digital signal processor (DSP), and a host bus interface and be connected to the processor 61_1 and/or the switch 63_1 through the host bus interface. In some example implementations, the NIC 64_1 may be integrated with any one or any combination of the processor 61_1, the switch 63_1, and the storage device 65_1.

In the application servers 50_1 to 50_n or the storage servers 60_1 to 60_m, the processors 51_1 to 51_m and 61_1 to 61_n may transmit commands to the storage devices 55_1 to 55_n and 65_1 to 65_m or the memories 52_1 to 52_n and 62_1 to 62_m and program or read data. In this case, the data may be data of which an error is corrected by an error correction code (ECC) engine. The data may be data processed with data bus inversion (DBI) or data masking (DM) and include cyclic redundancy Code (CRC) information. The data may be encrypted data for security or privacy.

In response to read commands received from the processors 51_1 to 51_m and 61_1 to 61_n, the storage devices 55_1 to 55_n and 65_1 to 65_m may transmit control signals and command/address signals to a nonvolatile memory device (e.g., a NAND flash memory device) NVM. Accordingly, when data is read from the nonvolatile memory device NVM, a read enable signal may be input as a data output control signal to output the data to a DQ bus. A data strobe signal may be generated using the read enable signal. The command and the address signal may be latched according to a rising edge or falling edge of a write enable signal.

The controller CTRL may control all operations of the storage device 65_1. In example implementations, the controller CTRL may include static RAM (SRAM). The controller CTRL may write data to the nonvolatile memory device NVM in response to a write command or read data from the nonvolatile memory device NVM in response to a read command. For example, the write command and/or the read command may be generated based on a request provided from a host (e.g., the processor 61_1 of the storage server 60_1, the processor 61_m of another storage server 60_m, or the processors 51_1 to 51_n of the application servers 50_1 to 50_n). A buffer BUF may temporarily store (or buffer) data to be written to the nonvolatile memory device NVM or data read from the nonvolatile memory device NVM. In some example implementations, the buffer BUF may include DRAM. The buffer BUF may store metadata. The metadata may refer to user data or data generated by the controller CTRL to manage the nonvolatile memory device NVM. The storage device 65_1 may include a secure element (SE) for security or privacy.

According to example implementations as described above, the storage devices 55_1 to 55_n, 65_1 to 65_m may include an on-chip syndrome checker OSC.

As described above, the nonvolatile memory device, the memory system, and the method of operating the memory system according to example implementations may, using the on-chip syndrome checker included in the nonvolatile memory device, reduce latency of ECC decoding and improve performance of the memory system by omitting the hard-decision ECC decoding and immediately performing the soft-decision ECC decoding when the hard-decision ECC decoding has a high probability of failure. By integrating the on-chip syndrome checkers in the nonvolatile memory devices, which has the smaller size than the ECC decoder, the performance may be efficiently improved without degrading the design margin of the nonvolatile memory device.

The various example implementations may be applied to any electronic devices and systems including a nonvolatile memory device. For example, the various example implementations may be applied to systems such as a memory card, a solid state drive (SSD), an embedded multimedia card (eMMC), a universal flash storage (UFS), a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, an automotive driving system, etc.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The foregoing is illustrative of various example implementations and is not to be construed as limiting thereof. Although a few example implementations have been described, those skilled in the art will readily appreciate that many modifications are possible in the example implementations without materially departing from the scope as defined by the appended claims.

What is claimed is:

1. A memory system comprising:
a nonvolatile memory device including a memory cell array and an on-chip syndrome checker circuit; and
a memory controller including an error check code (ECC) decoder and configured to control operation of the nonvolatile memory device,
wherein the nonvolatile memory device is configured to sequentially read out and store hard-decision data and soft-decision data from the memory cell array based on a read command transferred from the memory controller,
wherein the on-chip syndrome checker circuit of the nonvolatile memory device is configured to generate a syndrome result value by calculating a syndrome of the hard-decision data, and
wherein the ECC decoder of the memory controller is configured to, based on the syndrome result value, either perform hard-decision ECC decoding based on the hard-decision data or perform soft-decision ECC decoding based on the hard-decision data and the soft-decision data.

2. The memory system of claim 1, wherein, the nonvolatile memory device is configured to transfer, based on the syndrome result value being greater than a threshold value, the hard-decision data and the soft-decision data to the memory controller and the ECC decoder is configured to perform, based on the syndrome result value being greater than the threshold value, the soft-decision ECC decoding based on the hard-decision data and the soft-decision data, and
wherein, the nonvolatile memory device is configured to transfer, based on the syndrome result value being less than or equal to the threshold value, the hard-decision data without the soft-decision data to the memory controller and the ECC decoder is configured to perform, based on the syndrome result value being less than or equal to the threshold value, the hard-decision ECC decoding based on the hard-decision data.

3. The memory system of claim 1, wherein the nonvolatile memory device is configured to generate a flag having a first value based on the syndrome result value being less than or equal to a threshold value and having a second value based on the syndrome result value being greater than the threshold value.

4. The memory system of claim 3, wherein the nonvolatile memory device is configured to transfer the flag to the memory controller.

5. The memory system of claim 4, wherein the memory controller is configured to transfer a first transmission command to the nonvolatile memory device based on the flag having the first value, and transfer a second transmission command to the nonvolatile memory device based on the flag having the second value, and
wherein the nonvolatile memory device is configured to transfer the hard-decision data without the soft-decision data to the memory controller based on receiving the first transmission command, and transfer the hard-decision data and the soft-decision data to the memory controller based on receiving the second transmission command.

6. The memory system of claim 3, wherein the nonvolatile memory device is configured to transfer the flag and the hard-decision data to the memory controller based on the flag having the first value, and transfer the hard-decision data and the soft-decision data to the memory controller based on the flag having the second value.

7. The memory system of claim 1, wherein the nonvolatile memory device is configured to transfer the syndrome result value to the memory controller.

8. The memory system of claim 7, wherein the memory controller is configured to generate a flag having a first value based on the syndrome result value being less than or equal to a threshold value and a second value based on the syndrome result value being greater than the threshold value.

9. The memory system of claim 8, wherein the memory controller is configured to transfer a first transmission command to the nonvolatile memory device based on the flag having the first value, and transfer a second transmission command to the nonvolatile memory device based on the flag having the second value, and
wherein the nonvolatile memory device is configured to transfer the hard-decision data without the soft-decision data to the memory controller based on receiving the first transmission command, and transfer the hard-decision data and the soft-decision data to the memory controller based on receiving the second transmission command.

10. The memory system of claim 1, wherein the hard-decision data is divided into a plurality of sub-hard-decision data corresponding to units of ECC decoding, and the soft-decision data is partitioned into a plurality of sub-soft-decision data corresponding to the plurality of sub-hard-decision data, and
wherein the on-chip syndrome checker circuit includes a plurality of syndrome checker circuits configured to generate a plurality of sub-syndrome result values corresponding to the plurality of sub-hard-decision data by calculating syndromes of the plurality of sub-hard-decision data, respectively.

11. The memory system of claim 10, wherein the ECC decoder of the memory controller is configured to perform the hard-decision ECC decoding or perform the soft-decision ECC decoding, with respect to a unit of ECC decoding based on a sub-syndrome result value of a plurality of sub-syndrome result values.

12. The memory system of claim 10, wherein, the nonvolatile memory device is configured to transfer the sub-hard-decision data and the sub-soft-decision data to the memory controller, based on a sub-syndrome result value being greater than a threshold value, and the ECC decoder is configured to perform the soft-decision ECC decoding based on the sub-hard-decision data and the sub-soft-decision data, and
wherein, the nonvolatile memory device is configured to transfer the sub-hard-decision data without the sub-soft-decision data to the memory controller, based on the sub-syndrome result value being less than or equal to the threshold value, and the ECC decoder is configured to perform the hard-decision ECC decoding based on the sub-hard-decision data.

13. The memory system of claim 1, wherein the soft-decision data includes a most significant bit and a least significant bit, and
wherein the ECC decoder of the memory controller is configured to, based on the syndrome result value, either perform 2-bit soft-decision ECC decoding based on the hard-decision data and the most significant bit of the soft-decision data, or perform 3-bit soft-decision ECC decoding based on the hard-decision data, the most significant bit of the soft-decision data, and the least significant bit of the soft-decision data.

14. The memory system of claim 13, wherein the ECC decoder is configured to perform the 3-bit soft-decision ECC decoding based on the syndrome result value being greater than a first threshold value, perform the 2-bit soft-decision ECC decoding based on the syndrome result value being less than or equal to the first threshold value and greater than a second threshold value, and perform the hard-decision ECC decoding based on the syndrome result value being less than or equal to the second threshold value.

15. The memory system of claim 13, wherein the nonvolatile memory device is configured to transfer the hard-decision data, the most significant bit of the soft-decision data, and the least significant bit of the soft-decision data based on the syndrome result value being greater than a first threshold value, transfer the hard-decision data and the most significant bit of the soft-decision data without the least significant bit of the soft-decision data based on the syndrome result value being less than or equal to the first threshold value and greater than a second threshold value, and transfer the hard-decision data without both the most significant bit of the soft-decision data and the least significant bit of the soft-decision data based on the syndrome result value being less than or equal to the second threshold value.

16. A nonvolatile memory device comprising:
a memory cell array; and
an on-chip syndrome checker circuit configured to generate a syndrome result value by calculating a syndrome of hard-decision data and to read from the memory cell array,
wherein the nonvolatile memory device is configured to sequentially read out and store the hard-decision data and soft-decision data from the memory cell array, based on a read command transferred from a memory controller, to transfer the hard-decision data and the soft-decision data to the memory controller based on the syndrome result value being greater than a threshold value, and to transfer the hard-decision data without the soft-decision data to the memory controller based on the syndrome result value being less than or equal to the threshold value.

17. The nonvolatile memory device of claim 16, wherein the nonvolatile memory device is configured to generate a flag having a first value based on the syndrome result value being less than or equal to the threshold value and a second value based on the syndrome result value being greater than the threshold value.

18. The nonvolatile memory device of claim 17, wherein the nonvolatile memory device is configured to transfer the flag to the memory controller.

19. The nonvolatile memory device of claim 16, wherein the hard-decision data is divided into a plurality of sub-hard-decision data corresponding to units of error code check (ECC) decoding, and the soft-decision data is partitioned into a plurality of sub-soft-decision data corresponding to the plurality of sub-hard-decision data, and
wherein the on-chip syndrome checker circuit includes a plurality of syndrome checker circuits configured to generate a plurality of sub-syndrome result values corresponding to the plurality of sub-hard-decision data by calculating syndromes of the plurality of sub-hard-decision data, respectively.

20. A method of operating a memory system including a nonvolatile memory device and a memory controller, the method comprising:
sequentially reading out and storing, by the nonvolatile memory device, hard-decision data and soft-decision data from a memory cell array based on a read command transferred from the memory controller;
generating, by an on-chip syndrome checker circuit of the nonvolatile memory device, a syndrome result value by calculating a syndrome of the hard-decision data; and
based on the syndrome result value, performing, by an error check code (ECC) decoder of the memory controller, either hard-decision ECC decoding based on the hard-decision data or soft-decision ECC decoding based on the hard-decision data and the soft-decision data.
